(19) United States
(12) Patent Application Publication
(10) Pub. No.: US 2011/0037256 A1
(43) Pub. Date: Feb. 17, 2011

(54) BRAKE-LINE FASTENER

(75) Inventor: SCOTT CALNEK, Whitby (CA)

Correspondence Address: MacMillan, Sobanski & Todd, LLC;One Maritime Plaza, 720 Water Street, 5th Floor, Toledo, OH, 43604, US

(73) Assignee: GM GLOBAL TECHNOLOGY OPERATIONS, INC., DETROIT, MI (US)

(21) Appl. No.: 12/541,973

(22) Filed: Aug. 17, 2009

(51) Int. Cl. F16L 25/00

(52) U.S. Cl. 285/334.5

(57) ABSTRACT

The present invention provides a brake-line fastener adapted for secure engagement of a vehicle braking component with a tubular member, the brake-line fastener including an operator interface and a directional surface associated with one end of the brake-line fastener for rapid manual engagement between the brake-line fastener and the braking component utilizing a complementary threaded receiver.

### FIELD OF THE INVENTION

This invention relates to mechanical fasteners for vehicle braking systems. More specifically, the present invention relates to an improved tubular fastener and method of joining a brake-line to a braking module related to vehicle braking systems.

### BACKGROUND OF THE INVENTION

Vehicle brake-line fasteners are generally known and are subject to various industries specifications. Many of these known fasteners include an internal bore which is adapted to receive various braking components including a brake-line with flared ends. Generally, to receive the braking components, a brake-line fastener is supplied for pressing the flared ends of the braking components against the extended conical end of adjacent mating components to sealably secure the respective components against the environment.

However, many of these brake-line fasteners have disadvantages which are addressed by the present invention. For instance, as a result of misalignment during installation some brake-line fasteners are cross-threaded. Misalignment during installation often requires additional rotational force to overcome the side load. Side load is often present due to installation fixturing or tolerance stack-up of the brake-lines. Additional torque is required to overcome the side load; however this is often difficult to achieve by hand. Cross-threading of fasteners generally occurs due to insufficient thread engagement during the hand start process. A significant cost is often associated with the cross-threading of brake-line fasteners. Generally the components need to be replaced and the damaged parts scrapped. In addition, the side load effect my result in fasteners being under torqued. This creates the potential for numerous other issues once the system has been filled with fluid.

Some prior attempts to reduce cross-threading issues include engineered threaded fasteners which possess self-aligning features in the point and initial threads of the fastener. However, these self-aligning fasteners can still problematic.

In addition, during shipment various braking components may inadvertently deform causing further misalignment between the mechanical fasteners and braking components. As a result, the initial engagement between fastening components can be less than optimal resulting in the waste and scrapping of braking components due to cross-threading.

It therefore would be beneficial to provide an improved vehicle brake-line fastener which provides a shaped member with directional alignment. The shaped member provides improved fastening characteristics and enables increased rotational forces to be applied to the improved mechanical fastener when fastening components to the vehicle braking system.

### SUMMARY OF THE INVENTION

The present invention reduces the difficulties and disadvantages of the prior art by providing a method and device for mating two surfaces using a tubular fastener, the method including the steps to introduce the tubular fastener to the component surface and using an interface to apply nominal torque to achieve proper mating and device for mating a first surface and a second surface allowing a tube to pass therethrough. The present invention also includes a device interface addressing the difficulties and disadvantages of the prior art comprising an enlarged grippable surface, wherein the surface is longitudinally associated between a first and second end. The first end has an engagement surface and the second end has a directional surface.

### BRIEF DESCRIPTION OF THE DRAWINGS

FIG. 1 is an environmental view illustrating a brake-line fastener used to secure vehicle braking components, in accordance with a preferred embodiment of the invention.

FIG. 2 is a cross-sectional side illustration of the brake-line fastener of FIG. 1.

FIG. 3 is a side elevation view of the brake-line fastener of FIG. 1.

FIG. 4 is a perspective view of the brake-line fastener of FIG. 1.

FIG. 5 is a top plan view of the brake-line fastener of FIG. 1.

FIG. 6 is a bottom plan view of the brake-line fastener of FIG. 1.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

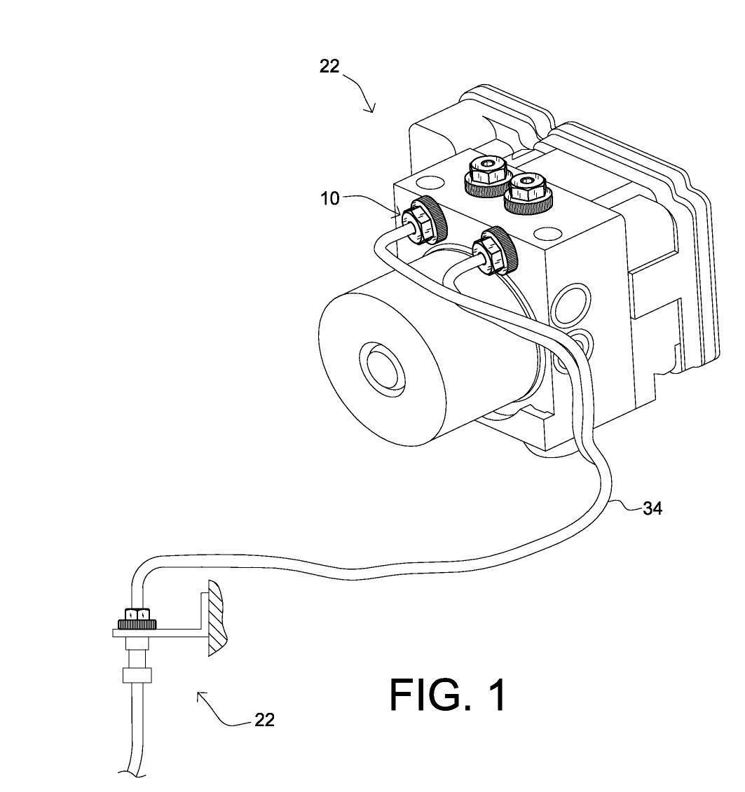

In general, the present invention provides an improved brake-line fastener generally referred to herein by reference numeral 10, which is adapted for rapid manual engagement for securing vehicle braking components (FIGS. 1-6). Generally, the improved brake-line fastener 10 includes a hand start feature 12 (FIG. 3) which helps an operator (not shown) overcome limited misalignment. The hand start feature 12 includes a directional surface 14 associated with the brake-line fastener 10 which helps align a threaded portion 16 of the brake-line fastener 10 with a threaded member 18 of a braking component 22 to be fastened.

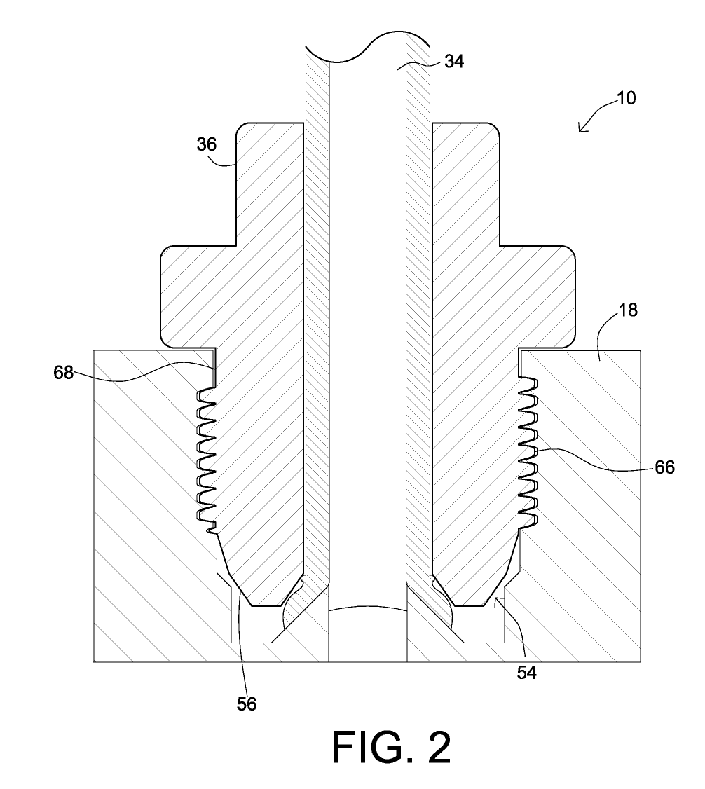

As illustrated in FIGS. 1-2, the brake-line fastener 10 generally includes a longitudinal shaft 24, a first end 26 and a second end 28, the first and second ends 26,28 being separated from each other and spaced along the longitudinal shaft 24. The longitudinal shaft 24 is illustrated with a passageway 32 adapted for receiving a brake line 34 centrally positioned therethrough. As further illustrated in FIG. 2, the first end 26 is generally associated with a head 36 while the second end 28 is generally associated with a helical thread 38 circumscribing the longitudinal shaft 24 from the second end 28 towards the head 36.

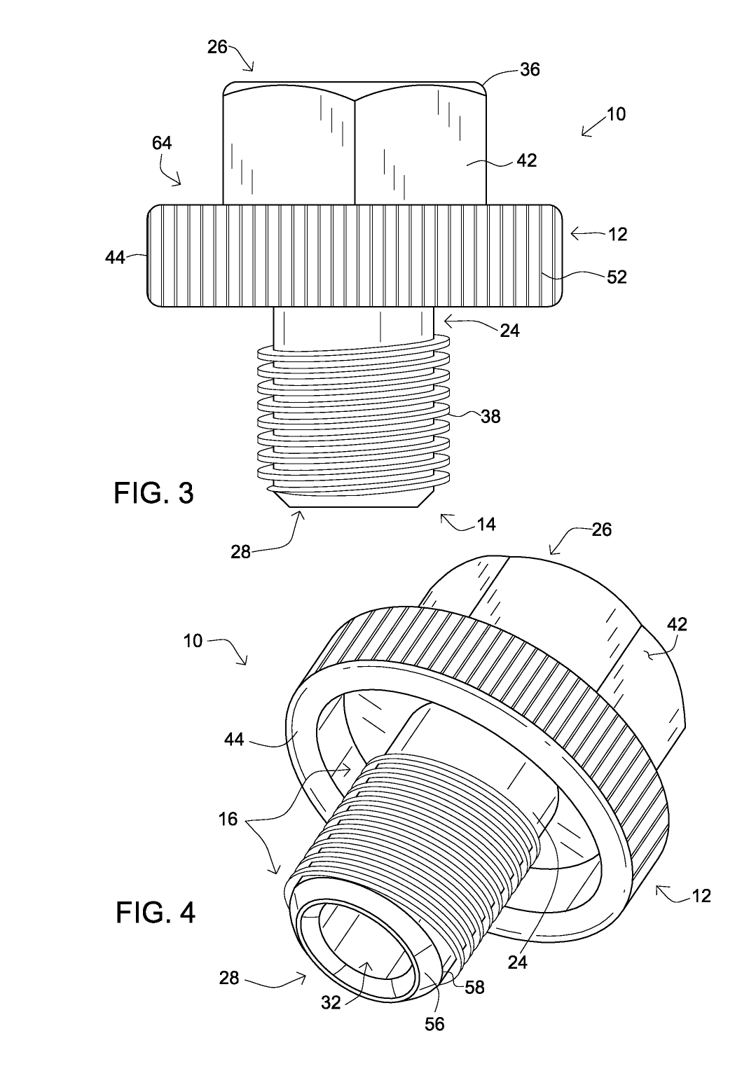

As an example, the embodiment of the invention illustrated in FIGS. 3-4 utilizes known head 36 configurations with a hexagonal engagement surface 42, though other head shapes may be utilized, including regular or irregular, for facilitating rotational movement from head drivers which engage the head, operably joining or loosening nearby braking components 22.

In addition, a shaped member 44, is positioned along the longitudinal shaft 24 between the first 26 and second end 28 and is illustrated with a frictional surface 52. Generally, the shaped member 44 facilitates rotational movement of the brake-line fastener 10, allowing for rapid engagement. As illustrated, the shaped member 44 extends radially outwardly from the longitudinal shaft 24, while the shaped member 44 is configured with a relatively large diameter, allowing for ready access to the shaped member 44. While the shaped member 44 is illustrated as being circular, other configurations may be permitted in use with the present invention, including symmetrical and asymmetrical shapes which facilitate ready rotation of the brake-line fastener 10.

As shown in FIGS. 3-6, the longitudinal shaft 24 generally presents the passageway 32 extending axially therethrough. The longitudinal shaft 24 has a generally circular shaped cross-section. The second end 28 generally presents a frustoconical configuration 54 with a radiused edge 56, annularly extending from an outer circumference 58 towards the passageway 32 at the directional surface 14.

The brake-line fastener 10 may be fabricated from a variety or known rigid materials including plastic or metal, preferably aluminum or steel, and may be formed utilizing a unitary one-piece fabrication from a mold or otherwise, or may also be formed utilizing a two-piece design with a metal nut and hand start feature 12. The brake line 34 may be fabricated from a variety of materials including rubber or metal, preferably steel tubing.

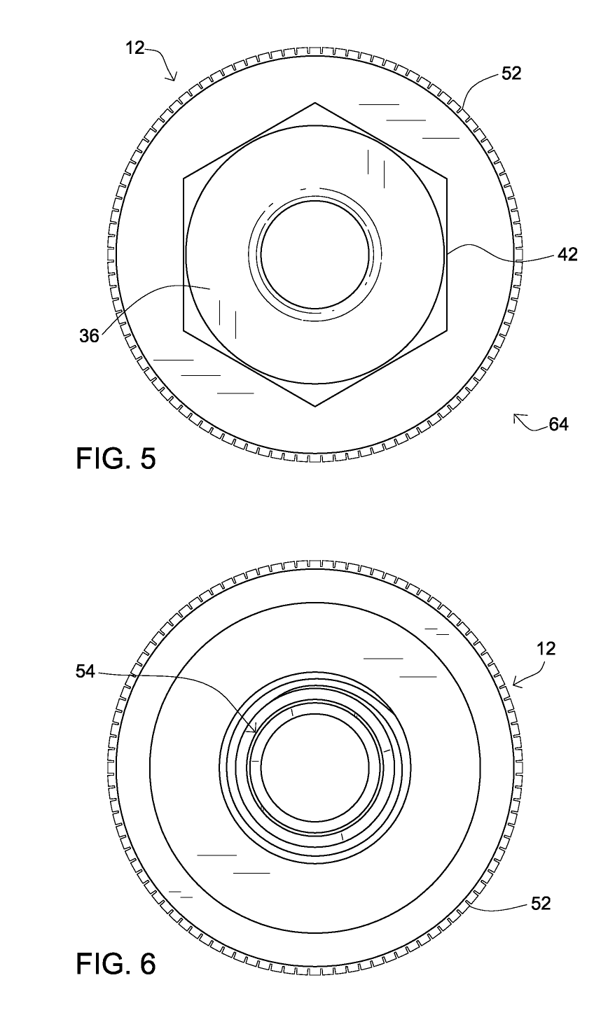

As illustrated in FIG. 1, in operation, the brake-line fastener 10 is configured to receive brake line 34, the brake-line fastener 10 being threadably received by the threaded member 18 of a braking component 22 such as brake modules and master cylinders. As illustrated in FIG. 2, once the brake line 34 has been received through the passageway 32 at the first end 26, the second end 28 of the brake-line fastener 10 is positioned near the threaded member 18. Once the directional surface 14 is positioned near the threaded member 18, an operator interface 64 is rotated allowing the directional surface 14 to align the helical thread 38 with an internal thread 66 of the threaded member 18. The operator interface 64 is then rotated until the brake-line fastener 10 is properly aligned. As further illustrated in FIGS. 5-6, the operator interface 64 is illustrated with a knurled frictional surface 52, any suitable surface may be utilized depending on the desired rotational features, including abraded, partially smooth and smooth edges. In addition, the operator interface 64 may utilize a break-away feature, such that once the desired rotation is achieved, the operator interface 64 is removed from the brake-line fastener 10.

A method, according to the present invention, of fastening plural vehicle braking components 22 is disclosed. The method including the steps of providing the brake line 34 and braking component 22 with threaded member 18. Receiving the brake line 34 at the first end 26 and through the passageway 32 associated with the brake-line fastener 10. Positioning the second end 28 near the threaded member 18 with the directional surface 14 overlying a threaded opening 68 associated with the threaded member 18. Rotating the frictional surface 52 of the operator interface 64 until the brake-line fastener 10 is properly aligned. Engaging the shaped member 36 associated with the first end 26 for mechanically securing the braking components 22.

The present invention has been described in an illustrative manner. It is understood that the terminology, which has been used, is intended to be in the nature of words of description rather than of limitation. While the invention has been described with respect to specific examples including presently preferred modes of carrying out the invention, those skilled in the art will appreciate that there are numerous variations and permutations of the above described methods, compositions and techniques that fall within the spirit and scope of the invention as set forth in the appended claims.

Having thus described the invention, what is claimed as new and desired to be secured by Letters Patent is as follows:

1. A fastener adapted for rapid manual engagement to a threaded member, said fastener comprising:
a tubular fastener having a longitudinal shaft, a first end separated along said longitudinal shaft by a second end associated with a shaped member, said first end associated with a helical thread extending along said longitudinal shaft from said first end towards said shaped member; and
a directional surface extending from said first end and adapted for aligning the fastener with the threaded member.

2. The invention of claim 1, wherein the fastener is a brake-line fastener.

3. The invention of claim 1, wherein said shaped member further comprises an operating interface adapted for rotational movement, said shaped member positioned along said longitudinal shaft between said first end and said second end, whereby said operating interface facilitating rotational movement of said helical thread along said threaded member.

4. The invention of claim 1, further comprising a directional surface extending from said first end and adapted for aligning the brake-line fastener with the threaded member.

5. The invention of claim 1, wherein said operator interface employs a break-away feature whereby said operator interface separates along said longitudinal shaft in response to rotational force.

6. The invention of claim 1, further comprising said brake-line fastener presenting a passageway therethrough for receipt of a brake line tube extending from a braking component through said passageway, said brake-line tube having a radiused edge inwardly received by said passageway, said brake-line fastener joining said brake line tube to said braking component at a junction of said threaded member with said helical thread.

7. A method for fastening a braking component having a threaded member to a tubular member at a brake-line fastener, the method including the steps of:
providing a brake-line fastener with an operator interface and a directional surface,
positioning a tubular member through said brake-line fastener at a passageway,
aligning a directional surface with the threaded member,
manually engaging the threaded member by a helical thread associated with one end of said brake-line fastener, and
rotating a head associated with a second end of said brake-line fastener whereby said braking component is securely fastened to said tubular member.

8. A brake-line fastener adapted for rapid manual engagement to a threaded member, said brake-line fastener comprising:
a tubular fastener having a longitudinal shaft, a first end separated along said shaft by a second end associated with a shaped member, said first end associated with a helical thread extending along said longitudinal shaft from said first end towards said shaped member;
said shaped member having a frictional surface providing an operating interface;
a circular member positioned along said longitudinal shaft and adapted for facilitating rotational movement of said tubular fastener, and
a directional surface extending from said first end and adapted for aligning the brake-line fastener with said threaded member.
